(19) United States
(12) Patent Application Publication
(10) Pub. No.: US 2011/0072613 A1
(43) Pub. Date: Mar. 31, 2011

(54) SPRING BIASED ROLLER FOR A SHOWER DOOR OR THE LIKE

(76) Inventor: James Hays, Langhorne, PA (US)

(21) Appl. No.: 12/889,666

(22) Filed: Sep. 24, 2010

Related U.S. Application Data
(60) Provisional application No. 61/272,461, filed on Sep. 25, 2009.

(51) Int. Cl. E05D 15/06

(52) U.S. Cl. 16/91

(57) ABSTRACT

The present invention relates to a roller for slidably mounting a panel such as a shower door to a rail or to a similar structure. The roller comprises a first cylindrical portion including a rolling surface for engaging the rail and a second cylindrical portion fixedly securable to the shower door panel. The second portion is concentrically mounted to the first portion and is rotatable relative thereto. A resilient member such as a tension spring connects the first portion to the second portion and stores a potential energy when a user moves the shower door in one direction and automatically urges the shower door to move in the opposite direction when released by the user. The invention also relates to a roller assembly comprising a roller and a rail.

### CROSS-REFERENCE TO RELATED APPLICATIONS

This application claims the benefit of U.S. Provisional Application Ser. No. 61/272,461, filed Sep. 25, 2009 and entitled SPRING BIASED ROLLER FOR A SHOWER DOOR OR THE LIKE, the specification of which is enclosed herein by reference.

### FIELD OF THE INVENTION

The invention relates to a support structure for a sliding door of a shower or a similar sliding panel arrangement that is spring biased to assist the door to automatically move in one direction.

### BACKGROUND OF THE INVENTION

Shower enclosures typically comprise a stall or base positioned adjacent to one or multiple walls and are enclose by one or multiple glass or polymer panels. To allow access to the shower while allowing keeping water inside the shower a door is generally provided.

There exist several possible door configurations. A first common configuration consists of a door mounted on hinges and pivoting about a vertical axis between an open position for accessing the shower and a close position for keeping the water inside the shower enclosure during its use. Some pivoting door configurations make use of mechanisms for maintaining the door in closed position to prevent unwanted opening of the door during the use of the shower, which could result in the shower leaking on the floor or on other structures, which in turn may cause water damages or create an environment favorable to the development of mold.

Although this solution may be advantageous, the use of a pivoting door is not possible or not practical in some instances. For example, the space available in some bathrooms may not allow for the use of a pivoting door of convenient size. Also, where the opening of the shower is relatively wide, the use of pivoting door may require the use of robust, relatively unaesthetic hardware to support a pivoting door, especially with glass doors which tend to be very heavy. Other instance where the use of pivoting doors is difficult includes mounting rigid doors to bath enclosures instead of shower curtains. In such instances, the use of sliding shower doors is generally preferred.

Sliding shower doors or other sliding panels used in bathrooms, kitchens or other similar environments typically comprise one or multiple vertical panels supported on or by rollers that ride in guide tracks. To operate the panel, the user pushes the panel in one direction to open the door and pushes it back in the opposite direction to close it. While this arrangement may be beneficial when pivoting doors are not suitable, sliding shower doors do not allow for automatic closing and therefore, are more prone to unwanted opening and water leaking. Further, some sliding doors tend to be very heavy, particularly if they are made from glass. This tends to make them difficult to move, especially for users with reduced strength and/or mobility (e.g. elderly people, handicapped people, etc.).

To avoid at least some of the above drawbacks, it would be desirable to provide an improved system that facilitates the operation of sliding door panels such that a panel, once moved to one position (opened, closed or to an intermediate position) can be moved back to its original position with less or no efforts.

### SUMMARY OF THE INVENTION

According to a broad aspect of an embodiment of the present invention, there is provided a roller for slidably mounting a panel to a structure. The roller includes a first cylindrical portion having a rolling surface for engaging one of the panel and the structure. The roller also includes a second cylindrical portion fixedly securable to the other one of the panel and the structure. The second cylindrical portion is concentrically mounted to the first cylindrical portion and is rotatable relative thereto in a first rotation direction and in a second, opposed rotation direction. A resilient member is also provided for connecting the first cylindrical portion to the second cylindrical portion for storing a potential energy during rotation of the second cylindrical portion relative to the first cylindrical portion in the first rotation direction, the stored potential energy urging rotation of the second cylindrical portion relative to the first cylindrical portion in the second rotation direction.

In an additional feature, the second cylindrical portion is concentrically mounted inside the first cylindrical portion of the first portion.

In another feature, the resilient member is a torsion spring including a first end connected to the first cylindrical portion and a second end connected to the second cylindrical portion.

In still another feature, the first cylindrical portion includes a first circular side wall having an outer face, an inner face and a circular edge, and an outer cylindrical wall having a first diameter and extending from the inner face of the circular side wall in a first axial direction, the outer cylindrical wall defining the rolling surface.

In yet another feature, the second cylindrical portion includes a second circular side wall having an outer face, an inner face and a circular edge. The second cylindrical portion also includes a second cylindrical wall having a second diameter, the second diameter being smaller than the first diameter of the outer wall of the first cylindrical portion. The second cylindrical wall extends from the inner face of the second circular side wall in a second axial direction, opposed to the first axial direction, to concentrically engage the outer cylindrical wall of the first cylindrical portion.

In another feature, the resilient member is concentrically mounted between the outer cylindrical wall of the first cylindrical portion and the cylindrical wall of the second cylindrical portion of the roller.

In a further feature, the resilient member is a torsion spring comprising a first end connected to the first cylindrical portion and a second end connected to the second cylindrical portion.

In still a further feature, the first cylindrical portion comprises a first circular side wall having an outer face, an inner face and a circular edge, an outer cylindrical wall having a first diameter and an inner cylindrical wall having a third diameter smaller than the first diameter of the outer wall. The inner and outer cylindrical walls concentrically extend from the inner face of the circular side wall in a first axial direction, the outer cylindrical wall defining the rolling surface of the roller.

In yet a further feature, the second cylindrical portion comprises a second circular side wall having an outer face, an inner face and a circular edge, and a second cylindrical wall having a second diameter. In this feature, the second diameter is smaller than the first diameter of the outer wall but larger than the third diameter of the inner cylindrical wall of the first portion. The second cylindrical wall extends from the inner face of the second circular side wall in a second axial direction, opposed to the first axial direction, to concentrically engage between the inner and outer cylindrical walls of the first cylindrical portion.

In another feature, the resilient member is concentrically mounted between the inner cylindrical wall of the first cylindrical portion and the cylindrical wall of the second cylindrical portion.

In still another feature, the roller further includes a connector fixedly mounted to the second cylindrical portion for connecting the second cylindrical portion to the panel.

In yet another feature, the connector comprises a pin extending outwardly from the outer face of the circular wall.

In a further feature, the connector comprises an elongated member extending radially relative to the second cylindrical portion. The elongated member has a first end fixedly connected to the circular wall of the second cylindrical portion and a second end, which comprises a connection means for securing the panel to the connector.

In yet a further feature, the connection means comprise a pin extending parallel to a longitudinal axis of the second cylindrical portion and towards the second cylindrical portion to locate the panel secured to the second cylindrical portion below the second cylindrical portion.

In another feature, the structure is a shower enclosure and the panel is a shower door.

According to another broad aspect of an embodiment of the present invention, there is provided a roller assembly for slidably mounting a panel to a structure. The roller assembly includes a rail secured to the structure, the rail having a first end, a second end and a top surface extending therebetween. The roller assembly also includes at least one roller adapted for moving the panel along the rail. The roller includes a first cylindrical portion including a rolling surface for engaging the top surface of the rail and for rolling therealong when the panel is moved between the first and second ends. The roller also includes a second cylindrical portion fixedly secured to the panel. The second cylindrical portion is concentrically mounted to the first cylindrical portion and is rotatable relative thereto in a first rotation direction and in a second, opposed rotation direction. The roller further includes a resilient member connecting the first cylindrical portion to the second cylindrical portion. The resilient member stores a potential energy during rotation of the second cylindrical portion relative to the first cylindrical portion in the first rotation direction when the panel is moved toward the first end of the rail. The stored potential energy urges rotation of the second cylindrical portion relative to the first cylindrical portion in the second rotation direction thereby urging the panel to move toward the second end of the rail.

In one feature, the top surface of the rail and the rolling surface of the first cylindrical portion are complementary to one another.

In a further feature, the rolling surface is concave and the top surface is convex.

In yet another feature, the first cylindrical portion comprises first and second side walls defining a pair of spaced apart flanges extending radially on each side of the rolling surface and the rail comprises an elongated guide member. The elongated guide member has a rectangular cross-section and is sized to engage the rolling surface between the first and second flanges.

In still another feature, the rolling surface comprises a plurality of radially projecting teeth meshing with complementary teeth on the top surface of the rail.

In another feature, the structure is a shower enclosure and the panel is a shower door.

### BRIEF DESCRIPTION OF THE DRAWINGS

A detailed description of examples of implementation of the present invention is provided hereinbelow with reference to the following drawings, in which:

FIG. 1 is a top perspective view of a shower having a shower door slidably mounted by means of a roller assembly, in accordance with one embodiment;

FIG. 2 is a top perspective view of the roller assembly shown in FIG. 1, showing a roller mounted on a rail;

FIG. 3 is another top perspective view of the rolling assembly shown in FIG. 2;

FIG. 4 is an exploded view of a rolling component for the roller shown in FIG. 2;

FIG. 5 is another exploded view of the rolling component shown in FIG. 4;

FIG. 6 is a front elevation view of a female portion of the rolling component shown in FIG. 4;

FIG. 7 is a cross-section view of the female portion shown in FIG. 6, taken along cross-section line VII-VII;

FIG. 8 is a front elevation view of a male portion of the rolling component shown in FIG. 4;

FIG. 9 is a cross-section view of the male portion shown in FIG. 8, taken along cross-section line IX-IX;

FIG. 10 is a cross-section view, taken along cross-section line X-X of FIG. 3, of the roller shown in FIG. 2, with a vertical panel attached to the rolling component via a connector;

FIG. 11 is a cross-section view of a roller, in accordance with an alternative embodiment, with a vertical panel attached to the rolling component via a connector;

FIG. 12 is a top perspective view of a roller, in accordance with yet another embodiment;

FIG. 13 is a cross-section view of a roller, in accordance with yet another embodiment, with a vertical panel attached to the rolling component via a connector;

FIG. 14 is a cross-section view of the rolling component shown in FIG. 2, taken along cross-section line XIV-XIV, with the spring member in a starting or unwound position;

FIG. 15 is another cross-section view of the rolling component shown in FIG. 14, with the spring member partly wound;

FIG. 16 is a front elevation view, partially cut, of the roller shown in FIG. 2, in use with a locking system the latch member of which is engaged;

FIG. 17 is a front elevation view, partially cut, of the roller shown in FIG. 2, in use with a locking system the latch member of which is released;

FIG. 18 is a roller assembly, in accordance with an alternative embodiment;

FIG. 19 is a cross-section, partially exploded view, showing assembly of a connector to a male portion, in accordance with one embodiment;

FIG. 20 is another cross-section, partially exploded view showing assembly of a connector to a male portion, in accordance with an alternative embodiment.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

The description which follows, and the embodiments described therein are provided by way of illustration of an example, or examples of particular embodiments of principles and aspects of the present invention. These examples are provided for the purpose of explanation and not of limitation, of those principles of the invention. In the description that follows, like parts are marked throughout the specification and the drawings with the same respective reference numerals.

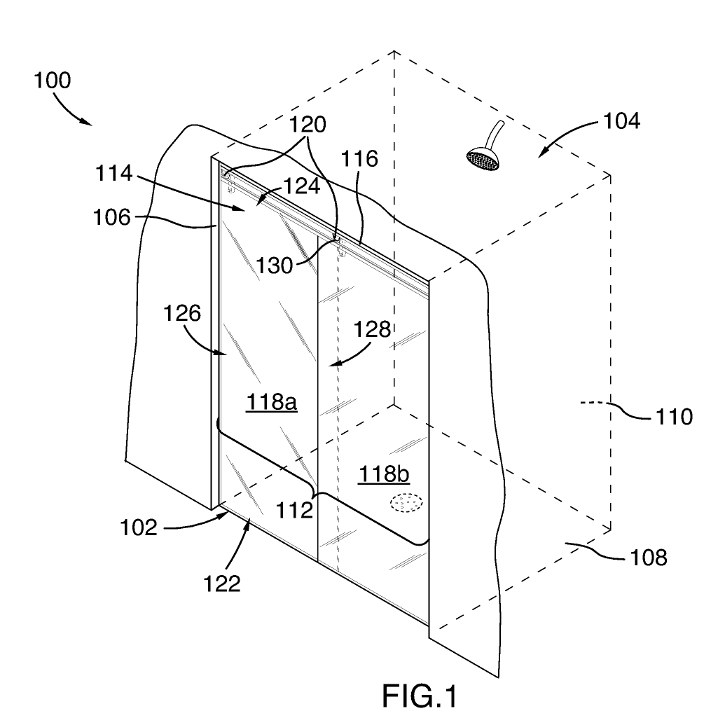

With reference to FIG. 1, there is shown a shower 100 comprising a base 102 mounted in a shower enclosure 104 defined by a pair of spaced-apart side walls 106, 108 and a back wall 110 extending perpendicular to the side walls 106, 108 and connecting the same. An opening 112 is defined between the side walls 106, 108 to access the shower enclosure 104. In the embodiment shown in FIG. 1, the opening 112 is closed by a sliding door assembly 114 comprising a pair of generally vertical panels 118a, 118b and a roller assembly for slidably mounting the mounted to the vertical panels 118a, 118b to the side walls 106, 108. The roller assembly comprises a generally horizontal track or rail 116 extending between the side walls 106, 108 of the shower enclosure 104, spaced above the base 102 to allow a user to conveniently enter the shower enclosure 104. The vertical panels 118a, 118b are suspended to the rail 116 by way of rollers 120 and are movable sideward to open and close the opening 112 of the shower 100. Each of the vertical panels 118a, 118b comprises a lower end 122, an upper end 124 and a pair of opposed side ends 126. In the embodiment shown in FIG. 1, each of the vertical panels 118a, 118b is suspended to the rail 116 by two rollers 120 attached to the upper end 124. As it will become apparent below, the rollers 120 of each of the vertical panels 118a, 118b are spring biased to facilitate lateral movement of the two vertical panels 118a, 118b to thereby assist the user in closing and/or to automatically close the shower opening 112 and prevent water leaks, or to assist the user in opening and/or to automatically open the shower opening 112.

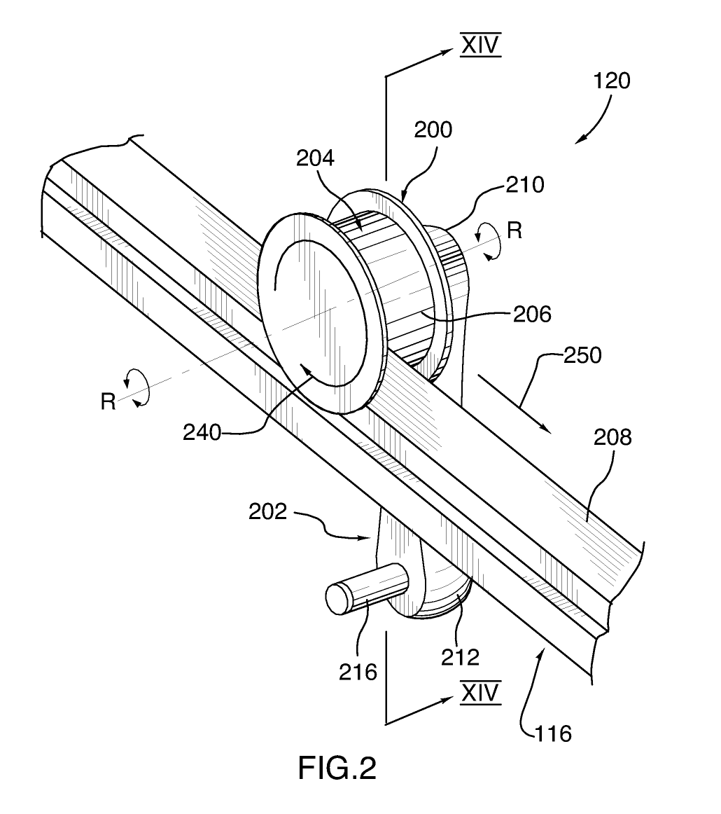

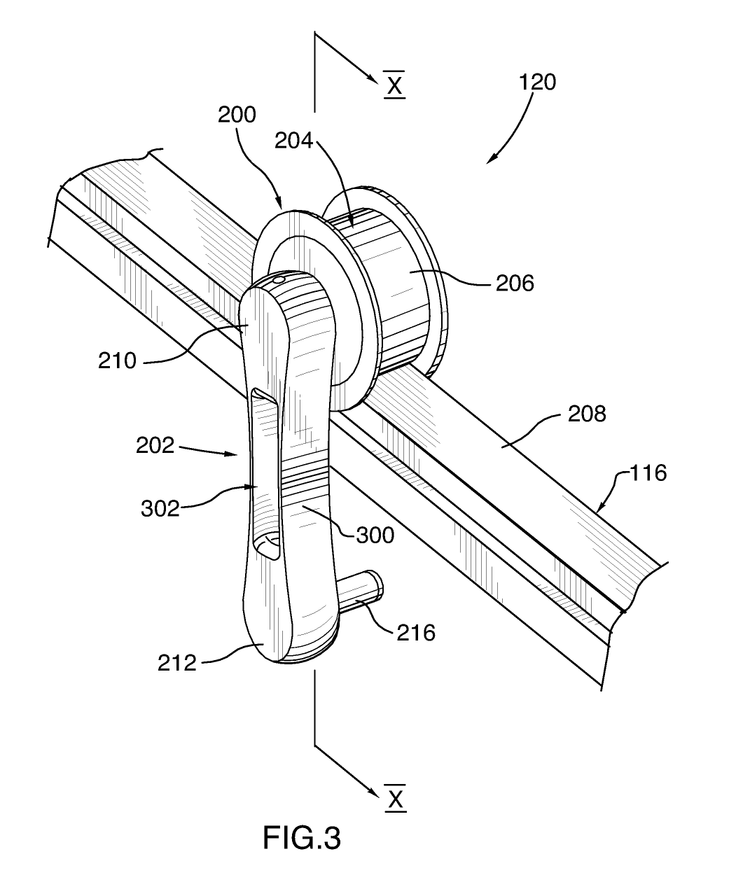

Now turning to FIGS. 2 and 3, the roller 120 will be described in connection with one embodiment. In this embodiment, the roller 120 comprises a rolling component 200 adapted for engaging the rail 116 and a connector 202 secured to the rolling component 200 for suspending a corresponding one of the vertical panels 118a, 118b to the rolling component 200, as it will become apparent below. The rolling component 200 has a cylindrical wall 204 which defines a rolling surface 206 adapted for contacting and resting upon a top surface 208 of the rail 116 such that, when the sliding door assembly 114 is assembled, the rail 116 substantially supports the rolling component 200 and the corresponding vertical panel 118 attached thereto. In the embodiment illustrated in FIG. 1, the rail 116 is located near the top of the shower opening 110 and the corresponding vertical panel 118 is suspended from the rail 116 by means of the roller 120, the lower end 122 of the vertical panels 118a, 118b being adjacent to the base 102 of the shower 100.

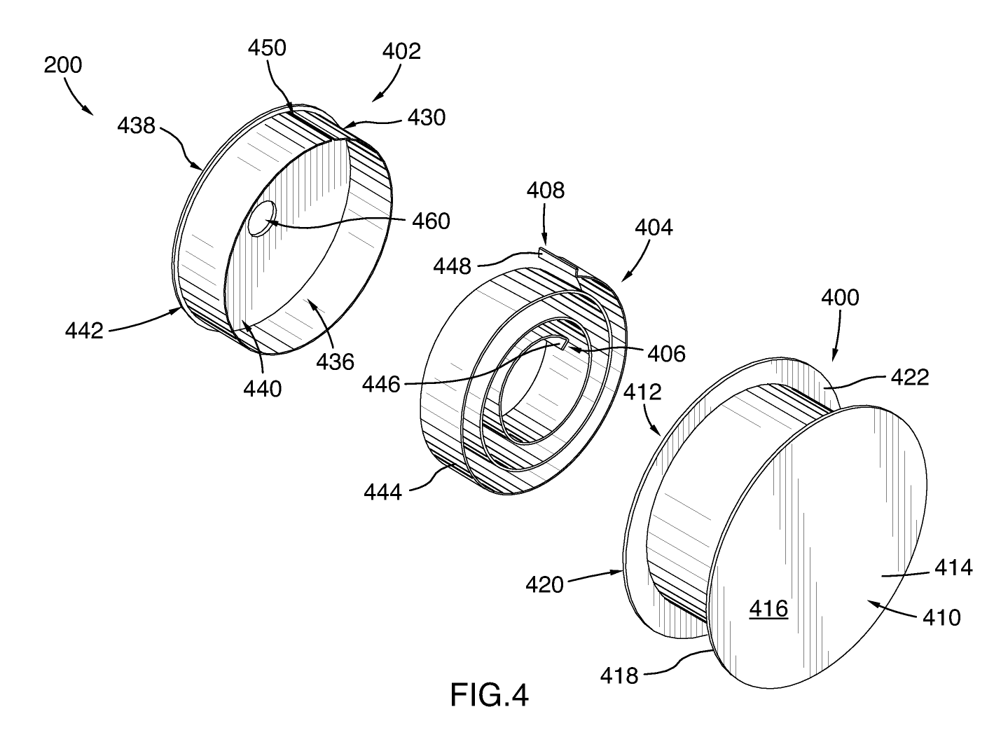

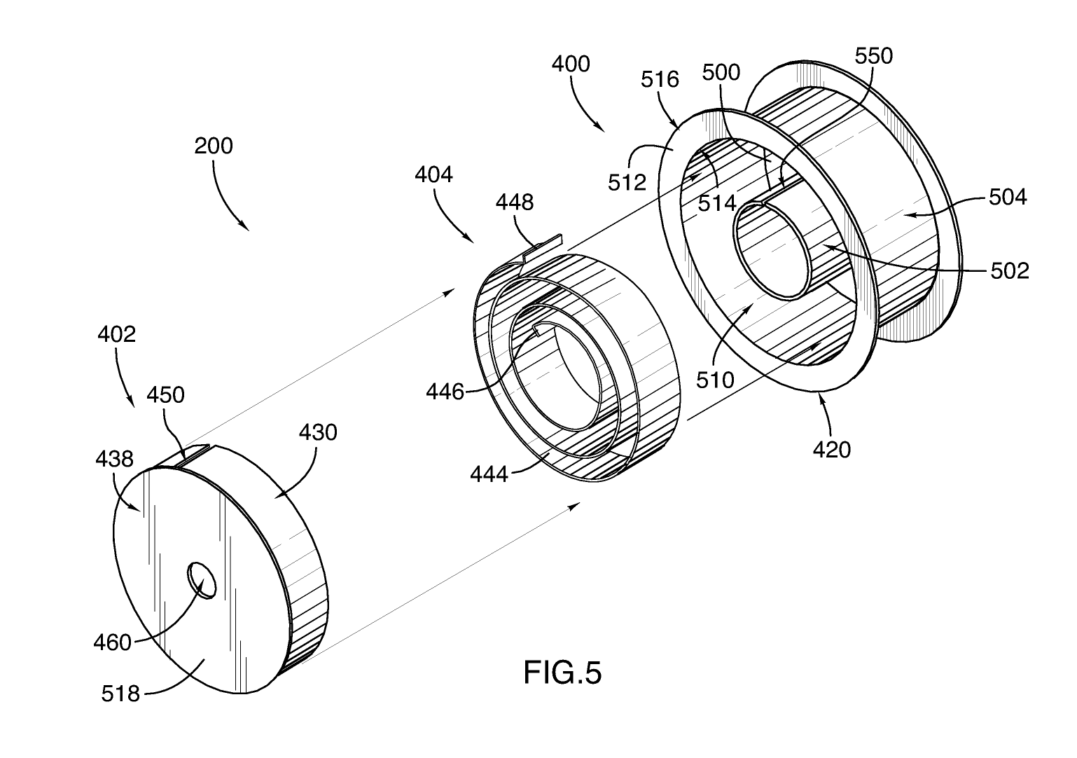

Now referring to FIGS. 4 and 5, the rolling component 200 comprises a first, female portion 400 and a second, male portion 402 rotatably engaging the female portion 400. As it will become apparent below, the male portion 402 is fixedly connected to the connector 202 and to the vertical panel 118a, 118b, and the female portion 400 is free to rotate about the male portion 402. Therefore, when the vertical panel 118a or 118b is moved sidewardly, the female portion 400 is allowed to rotate relative to the male portion 402 to displace the roller 120 along the rail 116.

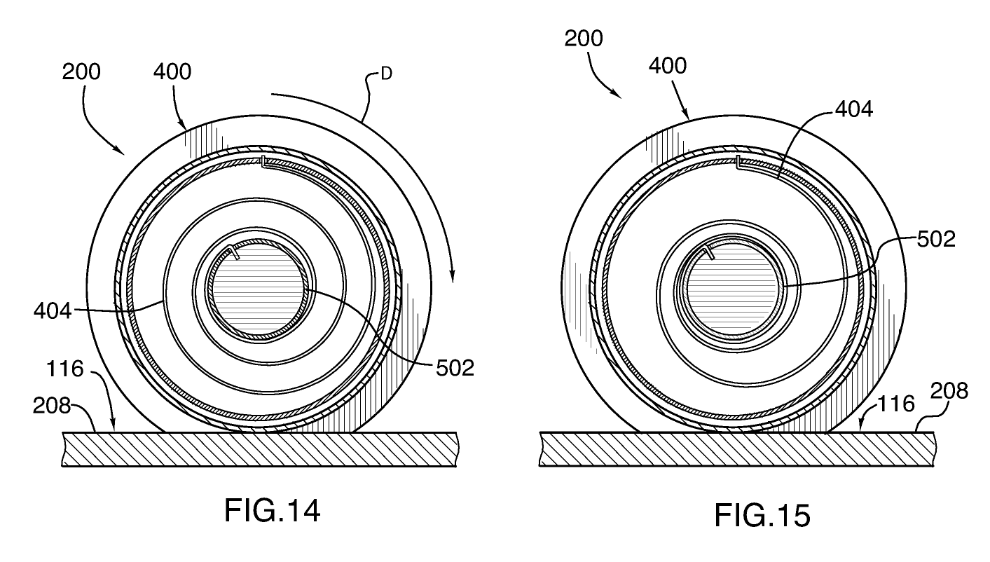

The rolling component 200 further comprises a resilient or spring member 404 which connects the male portion 402 to the female portion 400. In the embodiment illustrated in FIGS. 4 and 5, the spring member 404 comprises a first end 406 connected to the female portion 400 and a second end 408 connected to the male portion 402. When the vertical panel 118 is forced laterally in the first lateral direction 250, for instance by a user desirous to enter or exit the shower 100, the female portion 400 of the rolling component 200 engages the rail 116 and rotates relative to the male portion 402, thereby causing the first end 406 of the spring member 404 to move relative to the second end 408 of the spring member 404 (best shown in FIGS. 14 and 15). As it will be appreciated by a person skilled in the art, this causes the spring member 404 to be wound or unwound and to spring bias the rolling component 200. On the other hand, when the rolling component 200 is biased and the vertical panel 118a or 118b is released by the user (i.e. not lateral force is exerted on the vertical panel 118a or 118b, the wound spring member 404 will tend to unwind, therefore causing the rotation of the female portion 400 relative to the male portion 402 in an opposite rotation direction. Because the female portion 400 engages the rail 116, unwinding of the spring member 404 will cause the roller 120 and the panel 118a or 118b attached thereto to move back towards its original position (i.e. in a travel direction opposite to direction 250).

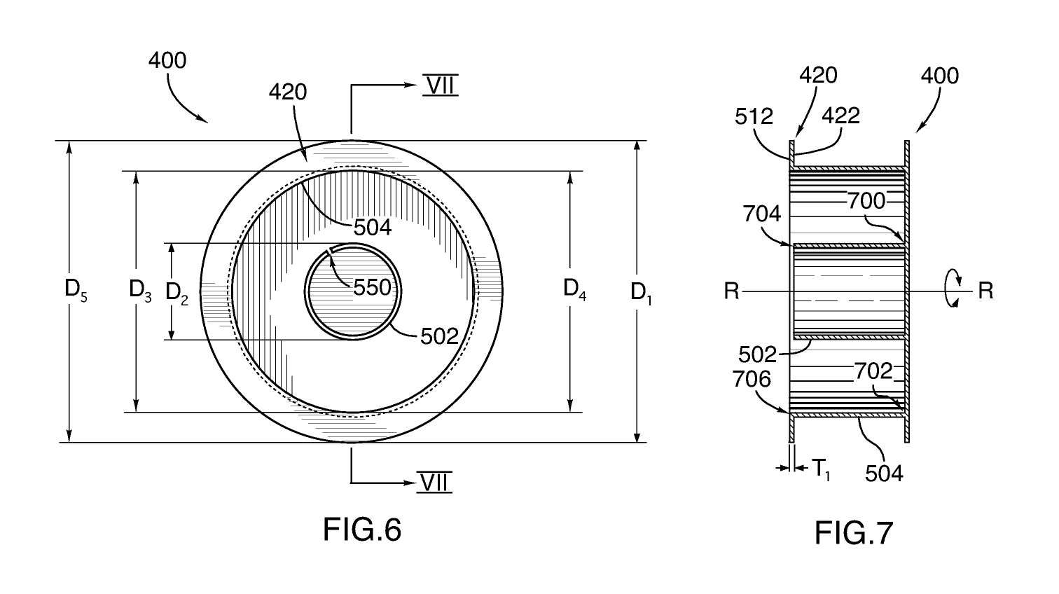

In the embodiment illustrated in FIGS. 4 to 7, the female portion 400 has a generally cylindrical shape and comprises a first and second side ends 410, 412. At the first side end 410 thereof, the female portion 400 comprises a circular wall 414 having an outer face 416, an inner face 500 and a circular edge 418 having a diameter D₁ (shown in FIG. 6). Extending from the inner face 500 of the circular wall 414, toward the second side end 412 of the female portion 400 (i.e. in a first axial direction), are two cylindrical walls, namely an inner cylindrical wall 502 and an outer cylindrical wall 504. The inner and outer cylindrical walls 502, 504 each have a first side end 700, 702 attached to the circular wall 414 and a second, opposed side end 704, 706 and extend longitudinally along a rotation axis R-R of the rolling component 200. The inner and outer cylindrical walls 502, 504 are positioned concentrically relative to one another so as to define a cylindrical space 510 therebetween. As it will become apparent below, the space 510 is sized to accommodate the male portion 402 of the rolling component 200 and the spring member 404. Accordingly, the inner cylindrical wall 502 has a diameter D₂, smaller that a diameter D₃ of the outer cylindrical wall 504 (best shown in FIG. 6).

At the second side end 412 thereof, the female portion 400 is provided with an annular wall 420 connected to the second side end 706 of the outer cylindrical wall 504. The annular wall 420 has an inner face 422 generally facing towards the second end 706 of the outer cylindrical wall 504 and an outer face 512 generally facing away from second end 706 of the outer cylindrical wall 504. The annular wall 420 further has an inner circular edge 514 having a diameter D₄ corresponding to the diameter D₃ of the outer cylindrical wall 504 and an outer circular edge 516 having a diameter D₅, which generally correspond to the diameter D₁ of the circular wall 414. As best shown in FIG. 7, the diameter D₃ of the outer cylindrical wall 504 is smaller than the diameters D₁ and D₅ of the circular and annular walls 414, 420 and therefore, the circular and annular walls 414, 420 protrude radially from the outer cylindrical wall 504. Accordingly, the circular and annular walls 414, 420 define spaced apart guiding surfaces for maintaining the rolling component 200 on the rail 116 as the vertical panel 118 is moved laterally along the rail 116, while the exterior of the outer cylindrical wall 504 defines the rolling surface 206 of the rolling component 200, as it will be best described below.

Further, because the annular wall 420 has a thickness T₁, the second end 704 of the inner cylindrical wall 502 is slightly recessed relative to the outer face 512 of the annular wall 420 (i.e. the second end 704 of the inner cylindrical wall 502 is in vertical alignment with the inner face 422 of the annular wall 420).

As shown in FIG. 5, the inner cylindrical wall 502 is provided with a longitudinal slot 550. In the embodiment illustrated, the longitudinal slot 550 extends generally from the second side end 508 towards the first side end 506 of the inner cylindrical wall 502, substantially parallel to the rotation axis R-R, and is configured to engage the first end 406 of the spring member 404, as it will become apparent below.

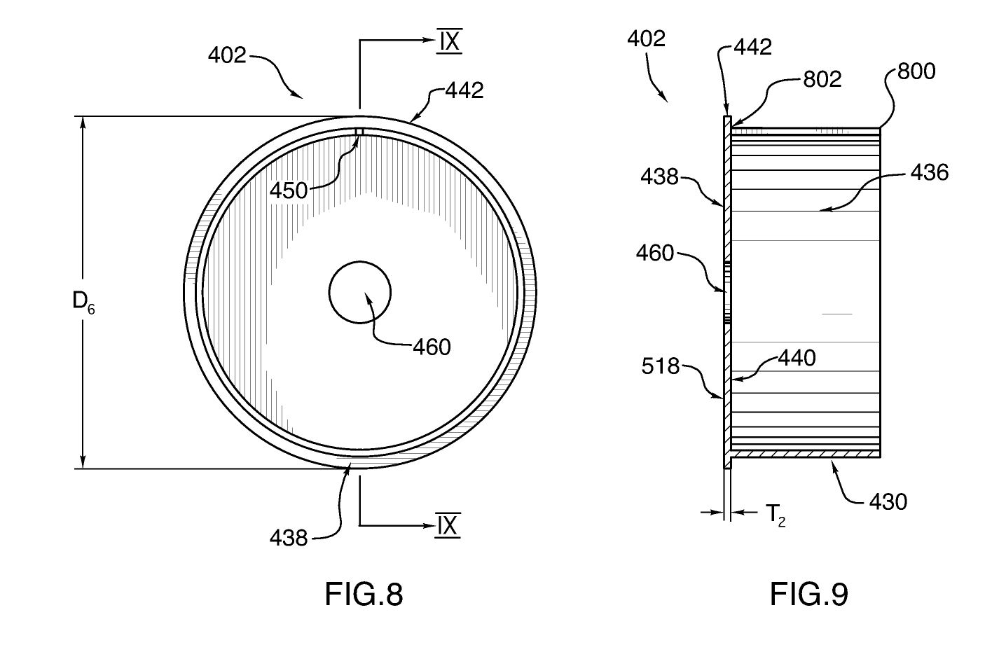

Referring to FIGS. 4, 5, 8 and 9, the male portion 402 of the rolling component 200 will now be described. The male portion 402 is configured to fit within the space 510 defined between the inner and outer cylindrical walls 502, 504 of the female portion 400 and to rotate relative thereto. More specifically, the male portion 402 comprises a generally cylindrical wall 430 having a first end 800, engaging the space 510, and a second, opposed end 802. The cylindrical wall 430 of the male portion defines a chamber 436 sized to receive the spring member 404 therein. The cylindrical wall 430 extends from a generally circular wall 438 in a second axial direction, opposed to the first axial direction of the female portion 400, and is provided with a slot 450 extending generally between the first and second ends 800, 802 thereof, substantially parallel to the rotation axis R-R, for engaging the second end 408 of the spring member 404.

More specifically, the generally circular wall 438 of the male portion 402 comprises an inner face 440 fixedly attached to the second end 802 of the cylindrical wall 430, an outer face 518 and a thickness T₂ (shown in FIG. 9), which corresponds generally to the thickness T₁ of the annular wall 420 of the female portion 400. In the embodiment illustrated in FIGS. 4 and 5, a fastening hole 460 is defined in the circular wall 438 and is generally centered thereon to accommodate a fastener for fastening the connector 202 to the male portion 402, as will be further described below. The cylindrical wall 430 further comprises a circular edge 442 having a diameter D₆ sized slightly smaller than the diameter D₄ of the inner circular edge 514 of the annular wall 512 of the female portion 400. Accordingly, when the male portion 402 is properly engaged in the female portion 400, the outer face 518 of the circular wall 438 of the male portion 402 is aligned with the outer face 512 of the annular wall 420 of the female portion 400 and yet, rotation of the male portion 402 relative to the female portion 400 is allowed.

Referring back to FIGS. 4 and 5, the spring member 404 interconnects the female and male portions 400, 402 and is adapted to urge rotation of the female portion 400 about the male portion 402. In this embodiment, the spring member 404 is made of a strip of resilient material (such as metal or plastic) that is wound into a spiral form. More specifically, the spring member 404 is a torsion spring comprising the first and second ends 406, 408 and a coiled portion 444 extending therebetween. The first end 406 comprises a first or inner tab 446 extending generally radially and inwardly, towards the rotation axis R-R, the inner tab 446 being receivable in the slot 550 to engage the inner cylindrical wall 502 of the female portion 400. Similarly, the second end 408 comprise a second or outer tab 448, extending outwardly and generally radially, the outer tab 448 being receivable in the slot 450 to engage the cylindrical wall 430 of the male portion 402. As it will be appreciated by a person skilled in the art, the rotation of the female portion 400 relative to the male portion 402 in one direction (e.g. when the door is opened) will cause the spring member 404 to wind and to store energy while the accumulated energy will cause the spring member 404 to unwind and to force rotation of the female portion 400 in the opposite direction and thereby to urge lateral movement of the vertical panel 118 attached to the rolling component 200 via the connector 202 (e.g. to close the door). It will be appreciated that the above configuration of the spring member 404 is provided merely as an example and that the spring member 404 may be attached to the female and male portions 400, 402 of the rolling component 200 using any other suitable means known to the skilled addressee.

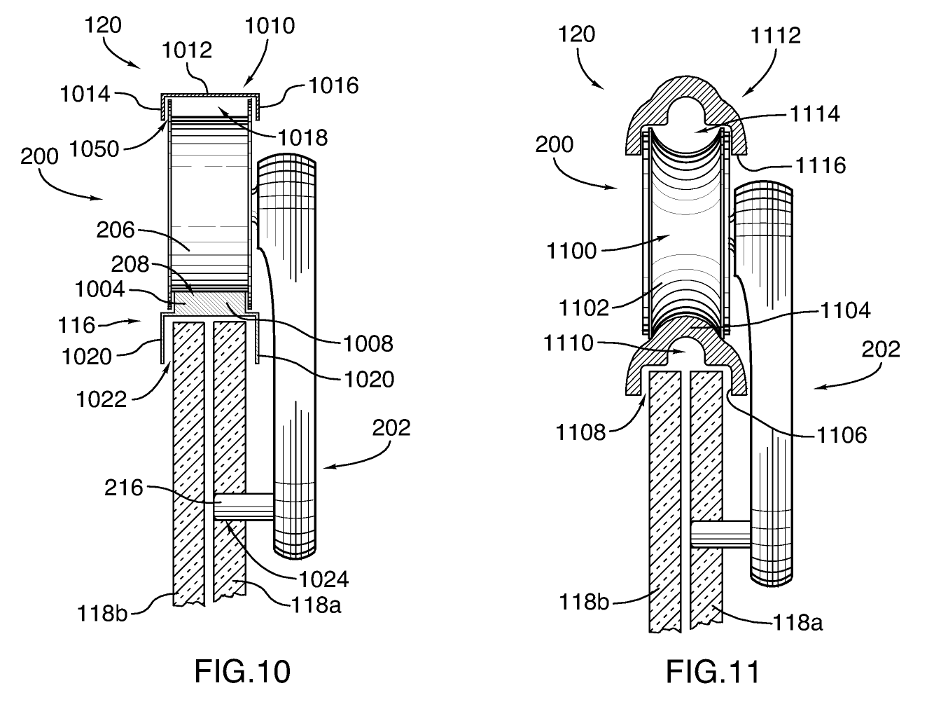

Having described the rolling component 200, the connector 202 attached thereto will now be described, with references to FIGS. 2 and 3. According to this embodiment, the connector 202 is generally elongated and comprises first and second opposed, bulbous end portions 210, 212. A generally biconcave central portion 300, which is substantially narrower than the first and second end portions 210, 212, extends between the first and second end portions 210, 212. The first end portion 210 is fixedly attached to the male portion 402 of the rolling component 200 and the connector 202 extends generally radially therefrom. A pin 216 extends from the second end portion 212, towards the rolling component 200 and parallel to the rotation axis R-R thereof, for engaging the vertical panel 118a, 118b, as best shown in FIG. 10. It will be appreciated that this configuration allows the weight of the vertical panel 118a, 118b to be balanced underneath the rail 116. Therefore, the weight of the vertical panel 118a, 118b will advantageously urge the rolling component 200 in an upright position, which is desirable to obtain proper rolling of the rolling component 200. Otherwise, the weight of the panel may cause the rolling component 200 to tip over.

In the illustrated embodiment, an opening 302 is defined in the central portion 300 of the connector 202. It will be appreciated that the substantially narrow shape of the central portion 300 and the opening 302 advantageously contribute to reducing the weight of the connector 202 to thereby reducing the amount of force needed to move the vertical panel 118 laterally while providing sufficient structural strength to allow the connector 202 to support the vertical panel 118. The substantially narrow shape of the central portion 300 and the opening 302 further reduce the amount of material needed to manufacture the connector 202, which advantageously allows substantial savings on manufacturing costs, especially in a case in which a large number of connectors are to be manufactured, and provides an aesthetically pleasant look to the roller 120.

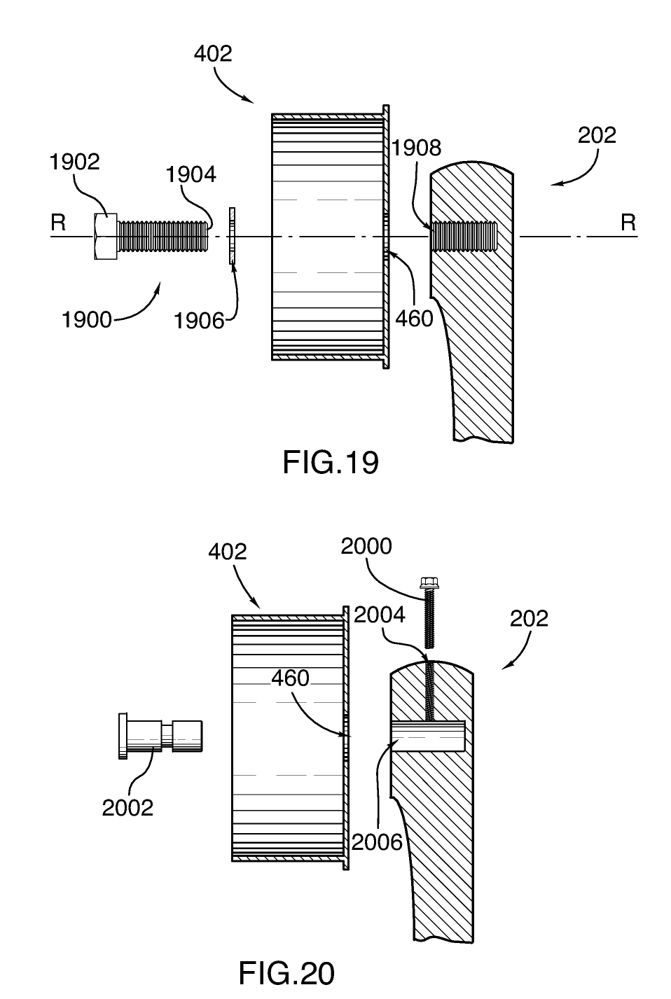

To assemble the roller 120, the connector 202 is secured to the male portion 402 of the rolling component 200. In the embodiment illustrated in FIG. 19, a threaded fastener 1900 is used for this purpose. The threaded fastener 1900 comprises a head 1902 and an opposed tip 1904. The tip 1904 of the threaded fastener 1900 is inserted through the fastening hole 460 of the male portion 402, from the chamber 436 towards the outer face 512. The head 1902 of the threaded fastener 1900 may be larger than the diameter of the fastening hole 460 such that the head 1900 may abut the inner face 440 of the circular wall 438 of the male portion 402, or a suitable washer 1906 may be used to prevent the head 1902 of the threaded fastener 1900 from passing through the fastening hole 460. The tip 1904 of the threaded fastener 1900 is then engaged in a corresponding threaded hole 1908 provided in the first end portion 210 of the connector 202. The threaded hole 1908 extends generally parallel to the rotation axis R-R of the rolling component 200 such that when the connector 202 is fastened to the male portion 402 of the rolling component 200, the connector 202 extends generally radially relative to the rolling component 200. Referring to FIG. 20, a set screw 2000 may further be used to prevent unwanted rotation of a grooved pin 2002 during operation of the roller 120. The set screw 2000 is fastened in a threaded bore 2004, which extends perpendicularly to a pin receiving hole 2006 defined in the connector 202, until the set screw 2000 abuts the grooved pin 2002 and exerts sufficient pressure thereon to prevent rotation of the connector 202 relative to the grooved pin 2002. Alternatively, the pin receiving hole 2006 may be internally threaded, similarly to the threaded hole 1908 described above, and the set screw 2000 may engage a longitudinal groove of a threaded fastener, generally similar to the threaded fastener 1900 described above, to prevent rotation of the connector 202 relative to the threaded fastener.

A person skilled in the art will appreciate that many configurations for attaching the connector 202 to the male portion 402 are possible. For instance, the connector 202 may instead comprise a connecting pin, similar to the pin 216, which extends from the first end portion 210 of the connector 202, generally parallel to the pin 216 (not shown). The connecting pin may be threaded at its free end such that it may be inserted through the fastening hole 460 of the male portion 402 to extend into the chamber 436 for threadingly engaging a nut. In yet another embodiment, the male portion 402 of the rolling component 200 and the connector 202 may be manufactured as a single, monolithic member.

The rolling component 200 is assembled by first assembling the spring member 404 with one of the female and male portions 400, 402 of the rolling component 200. In one embodiment, the spring member 404 is placed in the chamber 436 of the male portion 402 of the rolling component 200 and the outer tab 448 of the spring member 404 is inserted in the slot 450 of the cylindrical wall 430 of the male portion 402. In an alternative embodiment, the spring member 404 is placed in the space 510 of the female portion 400 of the rolling component 200 and the inner tab 446 of the spring member 404 is inserted in the slot 550 of the inner cylindrical wall 502 of the female portion 400.

The male portion 402 and the female portion 400 are then assembled together. The male portion 402 (to which the connector 202 was previously attached) is inserted in the space 510 of the female portion 400. Specifically, the cylindrical wall 430 of the male portion 402 is lined up concentrically relative to the outer cylindrical wall 504 of the female portion 400, with the chamber 436 of the male member 402 facing the space 510 of the female member 400. The female and male members 400, 402 are then moved towards each other. If the outer tab 448 of the spring member 404 was previously inserted in the slot 450 of the cylindrical wall 430 of the male portion 402, the inner tab 446 of the spring member 404 is aligned with the slot 550 of the inner cylindrical wall 502 of the female portion 400 such that movement of the male and female members 400, 402 towards each other will insert the inner tab 446 into the slot 550 of the inner cylindrical wall 502 of the female portion 400. If the inner tab 446 of the spring member 404 was previously inserted in the slot 550 of the inner cylindrical wall 502 of the female portion 400, the outer tab 448 of the spring member 404 is aligned with the slot 450 of the cylindrical wall 430 of the male portion 402 such that movement of the male and female members 400, 402 towards each other will insert the outer tab 448 into the slot 450 of the cylindrical wall 430 of the male portion 402. Once assembled, the roller 120 may be placed on the rail 116, as explained below.

The rolling component 200 and the connector 202 may be made of any suitable material known by the skilled addressee such as metal or a synthetic material. In one embodiment, the rolling component 200 and the connector 202 are made of a plastic material such as polyvinylchloride (PVC), acrylonitrile butadiene styrene (ABS), polycarbonate (PC), polyethylene (PE) or polypropylene (PP). This is particularly advantageous if the roller 120 is used in an environment in which it may be exposed to water, such as on a shower door, because plastics generally have a substantially high tolerance to corrosion.

Now turning to FIG. 10, the roller 120 is shown, assembled and mounted on the rail 116. The rail 116 itself is mounted over the panels 118a and 118b which extend vertically, substantially parallel to one another.

The rail 116 has a cross-sectional shape that is complementary to the shape of the rolling surface 206 of the rolling component 200. Specifically, the rail 116 comprises an elongated guide member 1004 which defines the top surface 208 of the rail 116 and a bottom end 1008. In the illustrated embodiment, the elongated guide member 1004 has a generally rectangular cross section and is slightly narrower than the outer cylindrical wall 504 of the female member 400. When the rolling component 200 is properly mounted on the rail 116, the top surface 208 of the rail 116 contacts the rolling surface 206 of the rolling component 200, and the elongated guide member 1004 is therefore located between the circular and annular walls 414, 420 of the female portion 400. This allows the rolling surface 206 of the rolling component 200 to roll on the top surface 208 of the rail 116 while the circular and annular walls 414, 420 of the female portion 400, which define flanges acting as guiding surfaces, substantially prevent the rolling component 200 to move transversely relative to the rail 116 and thereby advantageously prevent the roller 120 from accidentally being disengaged from the rail 116.

The rail 116 further comprises a pair of opposed sidewalls 1020 which extend generally downwardly from the elongated guide member 1004. The sidewalls 1020 are spaced apart to define a panel guiding channel 1022 therebetween for guiding the first panel 118a along the rail 116. In the illustrated embodiment, the panel guiding channel 1022 is adapted for guiding the first panel 118a, which is movable, along the second panel 118b, which is fixed. The width of the panel guiding channel 1022 is selected such as to accommodate the combined thickness of the first panel 118a and the second panel 118b as well as a sufficient clearance to allow the first panel 118a to slide past the second panel 118b.

To further prevent transverse movement of the rolling component 200 relative to the rail 116, an upper guiding track 1010 may further be provided. The upper guiding track 1010 is spaced upwardly from the rail 116 and is positioned slightly above the rolling component 200. The upper guiding track 1010 comprises a substantially flat top wall 1012 and a pair of opposed sidewalls 1014, 1016 extending generally downwardly on each side of the top wall 1012. The opposed sidewalls 1014, 1016 are spaced apart to define a roller guiding channel 1018 therebetween for receiving the rolling component 200 while allowing its rotation. To that end, the roller guiding channel 1018 is slightly wider than the rolling component 200 to allow the rolling component 200 to roll freely within the roller guiding channel 1018. In this configuration, the rolling component 200 is located within the roller guiding channel 1018 and the opposed sidewalls 1016 substantially prevent transverse movement of the rolling component 200 relative to the rail 116, as well as upward movement of the rolling component 200. It will be appreciated that it may be particularly advantageous to prevent transverse movement of the rolling component 200 in order to prevent it from tipping over when the first panel 118a attached thereto is substantially heavy.

Still referring to FIG. 10, a hole 1024 is provided in the first panel 118a to receive the pin 216 of the connector 202. In one embodiment, the hole 1024 has substantially the same diameter as the pin 216 to allow the pin 216 to be simply inserted in the hole 1024. When the pin 216 is engaged in the hole 1024 of the first panel 118a, the weight of the first panel 118a pulls the connector 202 downwardly and prevents it from rotating along with the female portion 400 when the rolling component 200 is rolling. Since the male portion 402 of the rolling component 200 is secured to the connector 202, the male portion 402 is also prevented from rotating. Further, the rail 116, which is securely positioned above the first panel 118a, prevents the first panel 118a from moving upwardly, and thereby further prevents the male portion 402 from rotating. Therefore, since the female portion 400 rotates when the rolling component 200 rolls, but the male portion 402 is prevented from rotating, the female portion 400 rotates relative to the male portion 402 when the rolling component 200 is rolling to wind or unwind the spring member 404.

Alternatively, prior to insertion, the pin 216 may be covered with an adhesive know in the art to secure the pin 216 in the hole 1024 and thereby prevent further movement of the connector 202 relative to the first panel 118a. The hole 1024 may also have a diameter which is slightly inferior to the diameter of the pin 216 to allow the pin 216 to be secured in the hole 1024 by a press-fit engagement. It will be appreciated that the pin 216 may be secured in the hole 1024 of the first panel 118a using any fasteners or fastening methods known to a person skilled in the art.

Now, with references to FIGS. 1, 14 and 15, the operation of the roller 120 will be described, in accordance with one embodiment. In this embodiment, the roller 120 supports the vertical panel 118 which acts as a door of the shower 100. In a starting position, shown in FIG. 14, the spring member 404 is unwound and at equilibrium. This position may correspond to the shower door 118 being in a closed position, for instance. In this embodiment, the shower door 118, when closed, abuts a left wall 106 of the shower enclosure 104. To open the shower door 118, a user facing the shower 100 exerts a lateral, rightward force on the shower door 118 to displace it rightwardly. Due to the friction of the rolling surface 206 of the rolling component 200 on the rail 116, the female portion 400 of the rolling component 200 rotates in the rotation direction indicated by arrow D. As the user keeps exerting a rightward force on the shower door 118, the rolling component 200 continues rolling rightwardly and the female portion 400 of the rolling component 200 keeps rotating relative to the male portion 402. As shown on FIG. 15, this causes the spring member 404 to deform from its starting or unwound position and to wind around the inner cylindrical wall 502 of the female portion 400 of the rolling component 200. As the user is exerting a force and moving the shower door 118 rightwardly, the user also provides kinetic energy to the roller 120 by causing the female portion 400 of the rolling component 200 to rotate relative to the male portion 402. This kinetic energy is transformed by the spring member 404 into potential energy, which is stored within the spring member 404. When the user lets go of the shower door 118, the spring member 404 urges the rolling component 200 back towards the starting, equilibrium position. It will be appreciated that the spring member 404 may be configured for providing the necessary force to move the shower door 118 back at the starting position without the need for any intervention from the user. Alternatively, the spring member 404 can be configured to provide a lesser degree of force that may not completely close the shower door 118 by itself, but can reduce the effort that would otherwise be required on the part of a user.

In an alternative embodiment, the spring member 404 may not be at equilibrium when in the start position, but already be partially wound. This would cause the shower door 118 to be biased against the left wall 106 of the shower enclosure 104. This configuration would advantageously enhance watertightness of the shower stall 102 when the shower door 118 is closed, especially if the shower door 118 is provided with a shower door seal or shower door gasket.

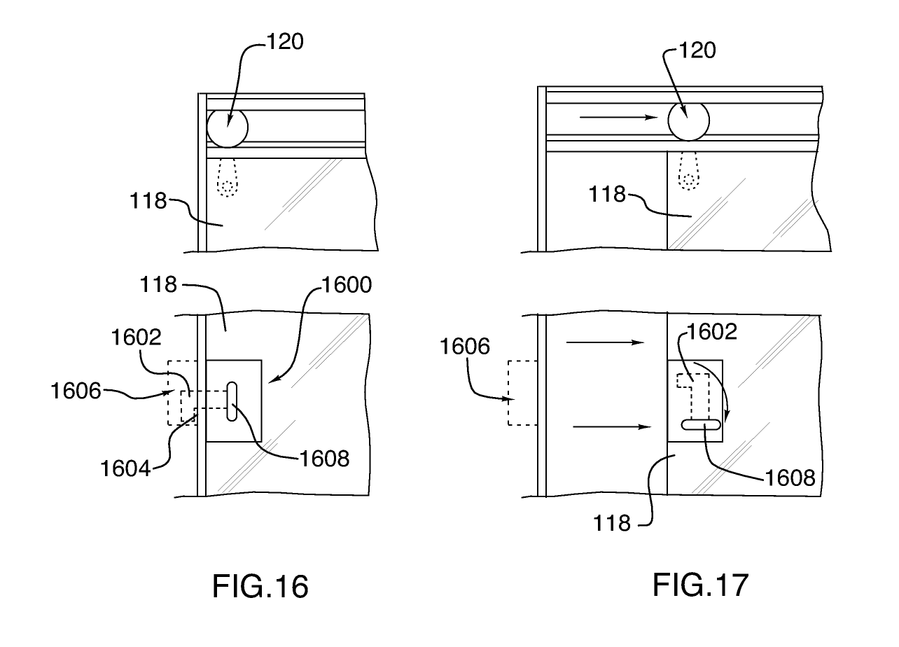

In yet another embodiment, the roller 120 may instead be configured such that the shower door 118 is biased towards an open position instead of a closed position. For instance, the roller 120 described herein may be used with a locking mechanism 1600, as shown in FIGS. 16 and 17. When in a locked position, shown in FIG. 16, the spring member 404 urges the shower door 118 rightwardly, but the shower door 118 is retained by a latch member 1602 which engages a retaining member, in this case a wall portion 1604 of a cavity 1606 defined in the left wall 106 of the shower enclosure 104. The latch member 1602 is operable using a handle 1608 which, when activated—by turning in the illustrated embodiment—releases the shower door 118. The spring member 404 may be configured for laterally moving the shower door without requiring any intervention from the user. In one embodiment, the latch member 1602 may only be released after a specific event, such as the payment of a fee or the like. This system may therefore advantageously be used to provide paying showers in public areas, for instance.

Although a single configuration, in which a single vertical panel 118 is movable and supported by two rollers 120, is shown in FIGS. 1, 14 and 15, the skilled addressee will appreciate that various other configurations may be considered. For instance, the vertical panel 118 may be supported by more than two rollers 120. In one embodiment, a shower door may comprise two vertical panels 118, each movable. In this case, the rolling components 200 supporting a first panel may act as abutments for the rolling components 200 supporting a second panel, in order to avoid damaging the panels by opening them too forcefully and accidentally ramming them in the opposed sidewall.

The rail 116 may also be shaped according to one of various configurations known to the skilled addressee. In the embodiment illustrated in FIG. 1, the side walls 106, 108 are substantially parallel and the rail 116 extends generally linearly therebetween. Alternatively, the shower 100 may comprise only a single side wall 106 and the back wall 110. This embodiment advantageously allows the shower 100 to be located in a corner of a room, such as a bathroom, adjacent to two existing walls. In this case, the rail 116 is curved in a substantially horizontal plane and extends between the side wall 106 and the back wall 110.

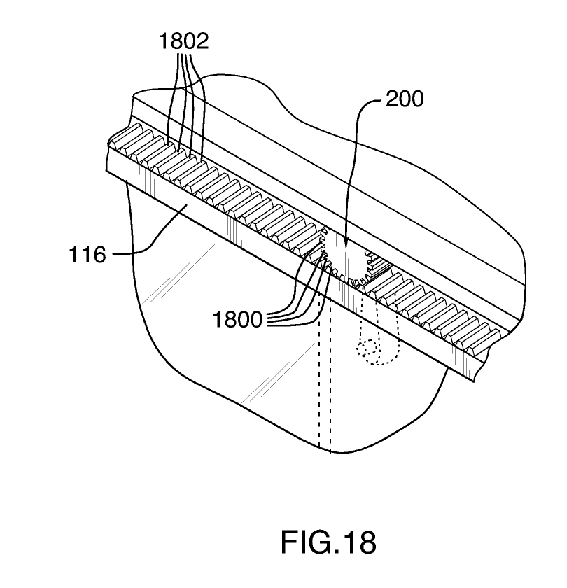

To prevent undesired unwinding of the spring member 404 during movement of the rolling component 200 along the rail 116, it may be desirable to enhance friction between the rolling component 200 and the rail 116. For instance, the rolling component 200, the rail 116, or both can be made of friction-enhancing materials that reduce the likelihood of the rolling component 200 starting to slip as the spring member 404 is being wound. An example of such material is an elastomer (e.g. rubber or a rubber-like coating), that can be applied to the rolling surface 206 of the rolling component 200 and/or to the top surface 208 of the rail 116. In addition to providing enhanced friction, the elastomeric material will also cushion movement of the vertical panel 116 to some degree. Alternatively, a surface finish may be applied to the rolling component 200, the rail 116 or both to enhance friction of the rolling component 200 on the rail 116. Such surface finish may include one or more of etching, embossing or otherwise treating the surface of the rolling component 200, the rail 116 or both, such that the treated surface becomes rougher. It will be appreciated that a surface finish may be used in conjunction with a friction-enhancing material to yet further reduce the likelihood of slippage of the rolling component 200. In yet another embodiment, shown in FIG. 18, the rolling component 200 may be gear-shaped and comprises, along its rolling surface 206, a plurality of teeth 1800 which are adapted for meshing with corresponding teeth 1802 provided on the rail 116, thereby substantially reducing or essentially eliminating slippage of the rolling component 200 on the rail 116.

In an alternative embodiment, the rail 116 may be configured to completely unwind the spring member 404 when the shower door 118 is in the closed position. This can be achieved by providing along the rail 116 localized areas with a low-friction material that registers with the rolling components 200 when the shower door 118 is in the closed position. At this point, the rolling components 200 are allowed to slip and thus completely unwind the spring member 404.

It will be appreciated that the rail 116 and the rolling component 200 may be constructed according to various other designs known to a skilled addressee which would allow the rolling component 200 to roll while being guided along the rail 116. For instance, in an alternative embodiment shown in FIG. 11, the rolling component 200 comprises a generally concave wall 1100 which defines a curved rolling surface 1102. The rail 116 has a generally dome-shaped cross-section and comprises a top bulging portion 1104 having a curvature substantially similar to the curvature of the curved rolling surface 1102 of the rolling component 200 to allow the rolling component 200 to be guided along the rail 116. A generally rectangular recess 1106 further extends upwardly from a lower end of the rail 116 into the rail 116. The rectangular recess 1106 is sized and shaped to form a panel guiding channel 1108 for guiding the first panel 118a along the second panel 118b, as explained above. In the illustrated embodiment, a hemicylindrical recess 1110 further extends from the rectangular recess 1106 upwardly towards the top bulging portion 1104. The hemicylindrical recess 1110 advantageously reduces the weight of the rail 116 while reducing the amount of material needed to manufacture the rail 116, which advantageously allows substantial savings on manufacturing costs, especially in a case in which a large number of rails are to be manufactured.

An upper guide track 1112 is further provided to substantially prevent the rolling component 200 from moving transversely relative to the rail 116. The upper guide track 1112 is spaced upwardly from the rail 116 and is adapted for receiving an upper portion 1150 of the rolling component 200. In the illustrated embodiment, the upper guide track 1112 is similar to the rail 116 and comprises a generally rectangular recess 1114 which extends upwardly from a lower end 1116 of the upper guide track 1112 into the upper guide track 1112. The rectangular recess 1114 is slightly wider than the rolling component 200 to allow the rolling component 200 to roll along the rail 116 while preventing the rolling component 200 from moving transversely relative to the rail 116. A person skilled in the art will appreciate that it may be advantageous for the upper guide track 1112 to be similar to the rail 116, for instance to reduce manufacturing cost if the sliding door assembly 114 is to be manufactured in large quantities.

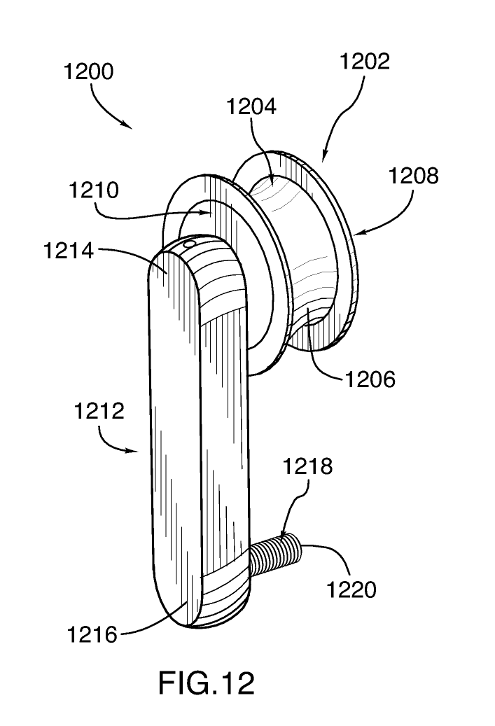

Now turning to FIG. 12, there is shown yet another embodiment of a roller 1200. The roller 1200 comprises a rolling component 1202 having a concave wall 1204 defining a curved rolling surface 1206, as described above in connection with concave wall 1100. The rolling component 1202 comprises a female portion 1208 and a male portion 1210 rotatably connected to the female portion 1208. The roller 1200 further comprises a connector 1212 secured to the male portion 1210 of the rolling component 1202. In this embodiment, the connector 1212 has a generally obround shape and has a first end 1214 secured to the male portion 1210 of the rolling component 1202 and a second, opposed end 1216. A pin 1218 extends away from the second end 1216 of the connector 1212, towards the rolling component 1202 and generally parallel to a rotation axis R-R thereof. As illustrated, the pin 1218 or a portion of the pin 1218 located at its free end 1220 may be threaded to receive a corresponding nut (not shown). When properly installed, the pin 1218 is inserted through a receiving hole of a corresponding panel. The pin 1218 has a length sufficient to allow its free end 1220 to protrude from the corresponding panel. The nut threadingly engages the free end 1220 of the pin 1218 and is tightened to sandwich the corresponding panel between the nut and the connector 1212 to thereby prevent further movement of the corresponding panel relative to the connector 1212.

It will be appreciated that the rolling component 200 may have other configurations. For instance, instead of a concave wall 1204 defining a rolling surface 1206 curving inwardly, the rolling component 200 may instead comprise a convex wall defining a rolling surface curving outwardly. In this embodiment, the top surface of the rail 116 may be shaped to fit this outwardly curved rolling surface. For instance, the rail 116 may comprise a longitudinal guide member in which is defined a concave recess, the curvature of which corresponds to the curvature of the outwardly curved rolling surface of the rolling component 200. Alternatively, the rolling component 200 may instead have a lenticular shape, in which case the rail 116 may be provided with a corresponding generally V-shaped recess. It will be appreciated that all of the above-described shapes may substantially prevent the rolling component 200 from moving transversely relative to the rail 116 when the rail 116 has a cross-section which is substantially complementary to the shape of the rolling component 200. Various other shapes and configurations known to the skilled addressee may be considered. In yet another embodiment, the rolling component 200 does not comprise guiding surfaces, such as the annular and circular walls 414, 512 of the female portion 400. Instead, the rolling component 200 is fully cylindrical and is adapted to engage a substantially planar top surface of the rail 116.

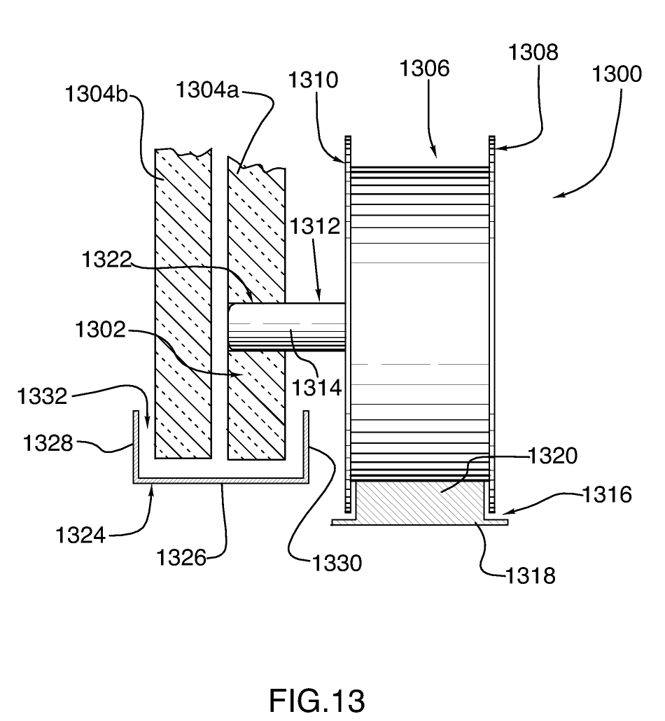

FIG. 13 shows yet another embodiment of a roller 1300. In the illustrated embodiment, the roller 1300 is located near a bottom portion 1302 of a vertical panel 1304a. The roller 1300 comprises a rolling component 1306 having a female portion 1308 and a male portion 1310, similarly to the rolling component 200 described above, and a connector 1312 for attaching the vertical panel 1304a to the rolling component 1306. In this embodiment, the connector 1312 comprises a pin 1314 extending from the male portion 1310 of the rolling component 1306, away from the female portion 1308 and generally parallel to the rotation axis R-R of the rolling component 1306. A rail 1316 is further provided for the rolling component 1306 to engage. The rail 1316 is secured on a bottom surface such a bathroom floor or a shower base (e.g. shower base 102) and comprises a base 1318 and an elongated guide member 1320 extending upwardly from the base 1318. The rail 1316 is positioned adjacent the vertical panel 1304a such that the pin 1314 may engage a hole 1322 of the vertical panel 1304a. In one embodiment, the vertical panel 1304a is supported by the pin 1314 of the rolling component 1306. Alternatively, the vertical panel 1304a may be supported in part by the rolling component 1306, and in part by a guide track 1324 extending below the vertical panel 1304a. In this embodiment, the guide track 1324 is distinct from the rail 1316 and comprises a base wall 1326 and a pair of opposed sidewalls 1328, 1330, spaced apart to define a panel guiding channel 1332 therebetween. The vertical panels 1304a and 1304b engage the panel guiding channel 1332 and are partly supported on the base member 1326. Although in this example, the rolling component 1306 supports the bottom portion 1302 of the vertical panel 1304a, the skilled addressee will understand that the present configuration may be configured to engage a top portion of the vertical panel 1304a.

In yet another embodiment, the male portion 402 of the rolling component 200 may be fixed to a wall structure such that the rolling component 200 is not allowed to move laterally. For instance, a first plurality of rolling components 200 may be aligned substantially horizontally near a ground surface and their male portion may be secured to the wall structure in this fashion. A second plurality of rolling components 200 may be aligned substantially horizontally and their male portion secured to the wall structure, above the first plurality of rolling components 200. A panel, such as a glass panel, would then be slid between the first and second pluralities of rolling components, the first plurality of rolling components engaging the bottom edge of the panel while the second plurality of rolling components engages the top edge of the panel. Sliding the panel between the first and second pluralities of rolling components in a first direction would wind the spring member of the rolling components, which would be urged back towards their original position when the panel is released.

Although the foregoing description related mainly to shower doors, it will be appreciated that the roller assembly described herein may be used in various other applications which comprise a sliding panel or structure that is designed to be moved between an opened and a closed position. Examples of such alternative arrangements include sliding doors for bathroom stalls, kitchen or bathroom cabinets and even drawer structures for bookshelves or audio-visual entertainment centers, among others. Shower doors using the rollers described herein may also be installed over the rim of an existing bathtub to create an enclosed space. Further, the roller 200 may be suitably used with generally vertical, horizontal or slanted panels.

Although the above description relates to a specific preferred embodiment as presently contemplated by the inventor, it will be understood that the invention in its broad aspect includes mechanical and functional equivalents of the elements described herein.

What is claimed is:

1. A roller for slidably mounting a panel to a structure, said roller comprising:
a first cylindrical portion including a rolling surface for engaging one of said panel and said structure;
a second cylindrical portion fixedly securable to the other one of said panel and said structure, said second cylindrical portion being concentrically mounted to said first cylindrical portion and being rotatable relative thereto in a first rotation direction and in a second, opposed rotation direction;
a resilient member connecting said first cylindrical portion to said second cylindrical portion for storing a potential energy during rotation of said second portion relative to said first cylindrical portion in said first rotation direction, said stored potential energy urging rotation of said second cylindrical portion relative to said first cylindrical portion in said second rotation direction.

2. A roller as claimed in claim 1, wherein said second cylindrical portion is concentrically mounted inside said first cylindrical portion.

3. A roller as claimed in claim 2, wherein said resilient member is a torsion spring comprising a first end connected to said first cylindrical portion and a second end connected to said second cylindrical portion.

4. A roller as claimed in claim 3, wherein said first cylindrical portion comprises a first circular side wall having an outer face, an inner face and a circular edge, and an outer cylindrical wall having a first diameter and extending from said inner face of said circular side wall in a first axial direction, said outer cylindrical wall defining said rolling surface.

5. A roller as claimed in claim 4, wherein said second cylindrical portion comprises a second circular side wall having an outer face, an inner face and a circular edge, and a second cylindrical wall having a second diameter, said second diameter being smaller than said first diameter of said outer wall of said first cylindrical portion, said second cylindrical wall extending from said inner face of said second circular side wall in a second axial direction, opposed to said first axial direction, to concentrically engage said outer cylindrical wall of said first cylindrical portion.

6. A roller as claimed in claim 5, wherein said resilient member is concentrically mounted between said outer cylindrical wall of said first cylindrical portion and said cylindrical wall of said second cylindrical portion.

7. A roller as claimed in claim 6, wherein said resilient member is a torsion spring comprising a first end connected to said first cylindrical portion and a second end connected to said second cylindrical portion.

8. A roller as claimed in claim 3, wherein said first cylindrical portion comprises a first circular side wall having an outer face, an inner face and a circular edge, an outer cylindrical wall having a first diameter and an inner cylindrical wall having a third diameter smaller than said first diameter of said outer wall, said inner and outer cylindrical walls concentrically extending from said inner face of said circular side wall in a first axial direction, said outer cylindrical wall defining said rolling surface.

9. A roller as claimed in claim 8, wherein said second cylindrical portion comprises a second circular side wall having an outer face, an inner face and a circular edge, and a second cylindrical wall having a second diameter, said second diameter being smaller than said first diameter of said outer wall but larger than said third diameter of said inner cylindrical wall of said first cylindrical portion, said second cylindrical wall extending from said inner face of said second circular side wall in a second axial direction, opposed to said first axial direction, to concentrically engage between said inner and outer cylindrical walls of said first cylindrical portion.

10. A roller as claimed in claim 9, wherein said resilient member is concentrically mounted between said inner cylindrical wall of said first cylindrical portion and said cylindrical wall of said second cylindrical portion.

11. A roller as claimed in claim 1, further comprising a connector fixedly mounted to said second cylindrical portion for connecting said second cylindrical portion to said panel.

12. A roller as claimed in claim 11, wherein said connector comprises a pin extending outwardly from said second cylindrical portion.

13. A roller as claimed in claim 11, wherein said connector comprises an elongated member extending radially relative to said second cylindrical portion, said elongated member having a first end fixedly connected to said second cylindrical portion and a second end, said second end comprising a connection means for securing said panel to said connector.

14. A roller as claimed in claim 13, wherein said connection means comprise a pin extending parallel to a longitudinal axis of said second cylindrical portion and towards said second cylindrical portion to locate said panel secured thereto below said second cylindrical portion.

15. A roller as claimed in claim 1, wherein said structure is a shower enclosure and said panel is a shower door.

16. A roller assembly for slidably mounting a panel to a structure, said roller assembly comprising:
a rail secured to said structure, said rail having a first end, a second end and a top surface extending therebetween;
at least one roller adapted for moving said panel along said rail, said roller comprising:
a first cylindrical portion including a rolling surface for engaging said top surface of said rail and for rolling therealong when said panel is moved between said first and second ends;
a second cylindrical portion fixedly securable to said panel, said second cylindrical portion being concentrically mounted to said first cylindrical portion and being rotatable relative thereto in a first rotation direction and in a second, opposed rotation direction;
a resilient member connecting said first cylindrical portion to said second cylindrical portion, said resilient member storing a potential energy during rotation of said second cylindrical portion relative to said first cylindrical portion in said first rotation direction when said panel is moved toward said first end of said rail, said stored potential energy urging rotation of said second cylindrical portion relative to said first cylindrical portion in said second rotation direction thereby urging said panel to move toward said second end of said rail.

17. A roller assembly as claimed in claim 16, wherein said top surface of said rail and said rolling surface of said first cylindrical portion are complementary to one another.

18. A roller assembly as claimed in claim 17, wherein said rolling surface is concave and said top surface is convex.

19. A roller assembly as claimed in claim 17, wherein said first cylindrical portion comprises first and second side walls defining a pair of spaced apart flanges extending radially on each side of said rolling surface and said rail comprises an elongated guide member sized to engage said rolling surface between said first and second flanges, said elongated guide member having a rectangular cross-section.

20. A roller assembly as claimed in claim 17, wherein said rolling surface comprises a plurality of radially projecting teeth meshing with complementary teeth on said top surface of said rail.

21. A roller assembly as claimed in claim 16, wherein said structure is a shower enclosure and said panel is a shower door.
